(19) United States
(12) Patent Application Publication
(10) Pub. No.: US 2024/0043205 A1
(43) Pub. Date: Feb. 8, 2024

(54) TRASH BIN WITH PIVOTABLE AND FOLDABLE PEDAL

(71) Applicant: Aderson Da Silva Carvalho, Flamengo (BR)

(72) Inventor: Aderson Da Silva Carvalho, Flamengo (BR)

(21) Appl. No.: 18/446,129

(22) Filed: Aug. 8, 2023

(30) Foreign Application Priority Data
Aug. 8, 2022 (BR) 2020220156617

(51) Int. Cl. B65F 1/14; B65F 1/16

(52) U.S. Cl. CPC B65F 1/1421; B65F 1/163

(57) ABSTRACT

The present utility model refers to a trash bin (1) with an pivotable and foldable pedal (2) comprising: a lid (3); and a support structure (4); the support structure (4) comprising fixed feet (5) and front retractable feet (6), wherein the fixed feet (5) and the front retractable feet (6) comprise suction cups (7); the support structure (4) further comprising a pivotable and foldable pedal (2) comprising a first portion (2a) and a second portion (2b); wherein the first portion (2a) of the pivotable and foldable pedal (2) is attached to a rod (H) of the support structure (4) by means of a hinge (D), so that the pivotable and foldable pedal (2) fold upwards at an angle of approximately 90° from its initial position (Pi) to its folded position (Pd); wherein the second portion (2b) of the pivotable and foldable pedal (2) is attached to the first portion (2a) of the pivotable and foldable pedal (2) and is articulated and rotates 360° around its axis; and wherein the lid (3) comprises a counterweight (8) on its front part.

### UTILITY MODEL FIELD

This application for a utility model refers to a trash bin with a pivotable and foldable pedal, whose function is to facilitate the opening of the bin lid by the user.

### BACKGROUND OF THE UTILITY MODEL

In the current context, with the emergence of new resistant and high-risk microorganisms for human health, there is a need to develop devices that facilitate the use of lidded trash bins using only the foot to open, thus avoiding contamination of the user's hands.

As professionals involved in the industry and trade of trash bins are aware, the state of the art presents several models of bins equipped with lids activated by pedals.

However, some difficulties are encountered by users when using state-of-the-art trash bins, for example, there is a difficulty in activating the pedal to open the trash bin from a safe distance, since users must get up and get close the trash bin to open the lid.

The Brazilian Utility Model Application No. MU 8202130-9, published on May 18, 2004, in the name of Glauco Jose Heinrich Loss, entitled “TRASH BIN LID OPENING SYSTEM WITH PEDAL HARDWARE” describes a trash can lid opening system with pedal-operated hardware.

The structure of the trash can in this document is assembled in steel and consists of two rods, and at one end of the rod that is located at the bottom of the trash bin, and is horizontal, is the pedal for activating the system, the other end of the lower rod is attached to the end of the trash bin by means of a support attached to the trash bin. The movement created by actuating the pedal causes the lower rod to rotate 45 degrees on its own axis, causing the upper rod, which is vertical and is fixed at the opposite end to the pedal, on the lower rod by means of a movable axis and at the other end, it is also fixed to a movable axis fixed to the lid of the trash bin, being precipitated upwards causing the lid of the trash bin to open.

The structure of MU 8202130-9 differs from the support structure of the trash bin with a pivotable and foldable pedal of the present utility model in that the actuation pedal is not articulated and is not foldable. Furthermore, the structure of MU 8202130-9 does not have additional retractable front feet comprising suction cups, which provide greater stability to the trash bin.

As can be seen above, the state-of-the-art trash bins do not have a pivotable and foldable pedal that allows the trash bin to be used on both sides of the toilet and, also allows the user to activate the pedal and open the trash bin lid at a safe distance and without getting up from the toilet.

Thus, the solution found by the present utility model for the problems of the state of the art is the use of a trash bin with a pivotable and foldable pedal, which allows the user to open the trash bin sitting on the toilet, that is, without having to get up and touch the lid of the trash bin to open it.

In addition, the trash bin with a pivotable and foldable pedal of this utility model does not need a battery or any type of energy source, being economical and easy to use.

### SUMMARY

To solve the afore-mentioned problem, this utility model will provide significant improvements in relation to state-of-the-art pedal-activated trash bins.

In particular, this utility model refers to a trash bin with a pivotable and foldable pedal comprising:
a lid; and
a support structure;
the support structure comprising fixed feet and front retractable feet, the fixed feet and the front retractable feet comprising suction cups;
the first portion of the pivotable and foldable pedal being secured to a rod of the support structure by means of a hinge, so that the pivotable and foldable pedal is folded upwards at an angle of approximately 90° from its initial position to its folded position;
wherein the second portion of the pivotable and foldable pedal is attached to the first portion of the pivotable and foldable pedal and is pivotable through 360° around its axis; and
wherein the lid comprises a counterweight on its front part.

### BRIEF DESCRIPTION OF FIGURES

The structure and use of the pivotable and foldable pedal trash bin of this utility model, together with additional advantages thereof, can be better understood by referring to the attached drawings and the following description:

FIG. 1 shows the perspective view of the trash bin with a pivotable and foldable pedal;

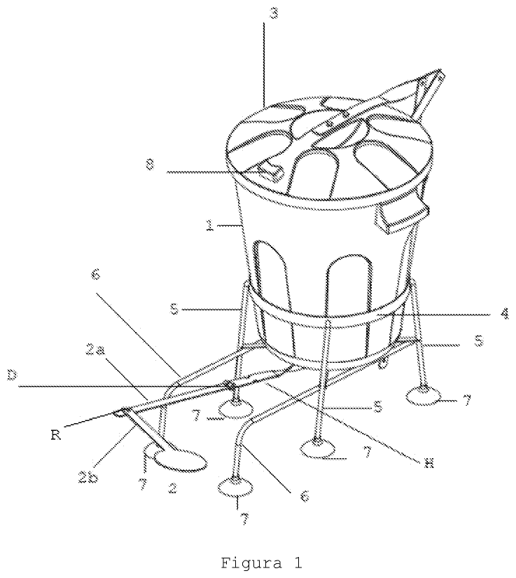

FIG. 2 shows the perspective view of the support structure of the trash bin with a pivotable and foldable pedal;

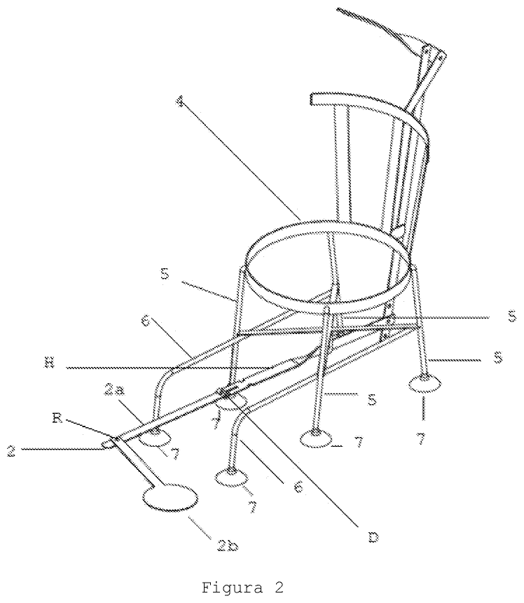

FIG. 3 shows the side view of the trash bin with a pivotable and foldable pedal and illustrates its operation when the pedal is activated by the user;

FIG. 4 shows the top view of the trash bin showing the articulation of the second portion of the pivotable and foldable pedal;

FIG. 5 shows the perspective view of the trash bin with a pivotable and foldable pedal when the pedal is activated by the user;

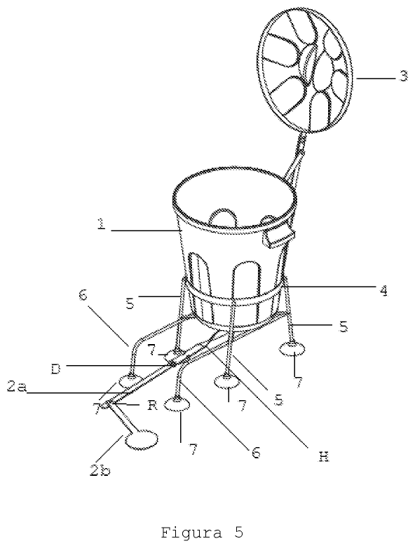

FIG. 6 is the side view of the trash bin showing the pedal being folded up; and

FIG. 7 shows the bottom perspective view of the trash bin with a pivotable and foldable pedal.

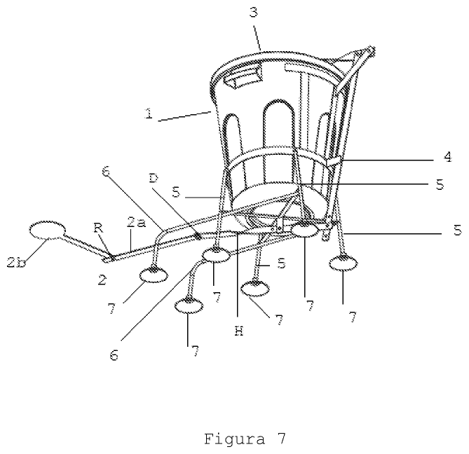

### DETAILED DESCRIPTION OF THE UTILITY MODEL

Although the present utility model can be presented in different embodiments, the present detailing, accompanied by the drawings, indicate a preferred embodiment, emphasizing that it should be considered an example of the principle of the utility model and not limitation.

This utility model refers to a trash can 1 with a pivotable and foldable pedal 2 comprising:
a lid 3; and
a support structure 4;
the support structure 4 comprising fixed feet 5 and front retractable feet 6, the fixed feet 5 and the front retractable feet 6 comprising suction cups 7;
the support structure 4 further comprising a pivotable and foldable pedal 2 comprising a first portion 2a and a second portion 2b;
whereby the first portion 2a of the pivotable and foldable pedal 2 is attached to a rod H of the support structure 4 by means of a hinge D, so that the pivotable and foldable pedal 2 is folded upwards at an angle of approximately 90° from its initial position Pi to its folded position Pd;
whereby the second portion 2b of the pivotable and foldable pedal 2 is attached to the first portion 2a of the pivotable and foldable pedal 2 and is articulated and rotates 360° around its axis;
wherein the lid 3 comprises a counterweight 8 on its front part.

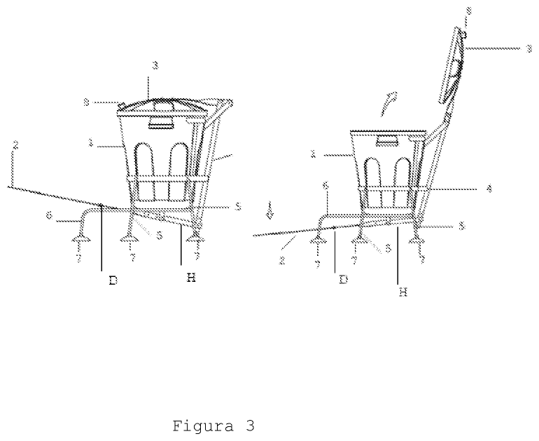

The pivotable and foldable pedal 2 of the support structure 4 together with the rod H, which has an L shape and is connected to the lid 3, has the function of opening the lid 3 to the degree necessary for the use of the trash bin 1 when the pivotable and foldable pedal 2 is activated by the user, as can be seen in FIG. 3, where the arrows indicate the movement of stepping on the pivotable and foldable pedal 2 performed by the user and the opening of the lid 3 in view of this movement.

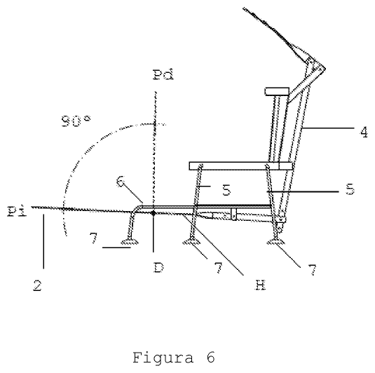

The first portion 2a of the pivotable and foldable pedal 2 is attached to the rod H of the support structure 4 by means of a hinge D, which allows the articulated and foldable pedal 2 to be folded at an angle of approximately 90° upwards from its initial position Pi to a folded position Pd, in order to collect the articulated and foldable pedal 2 so that the trash bin 1 is eventually stored inside a box when not in use, as can be seen in FIG. 6.

In a particular embodiment, the rod H has an elevation (not shown) that has a height depending on the adjustment needed to open the lid 3, on which the hinge D is fixed. The elevation has the function of giving more height to the pivotable and foldable pedal 2 to help in activating it to open and close the lid 3 at a desirable angle.

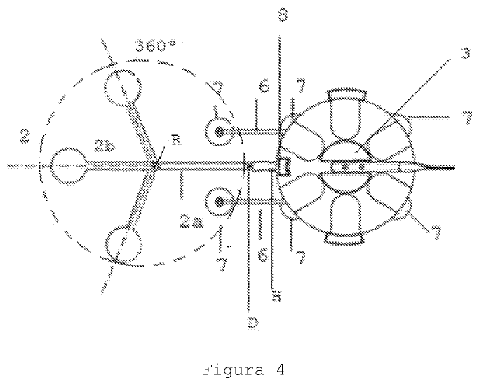

The second portion 2b of the pivotable and foldable pedal 2 is attached to the first portion 2a of the pivotable and foldable pedal 2 by means of a pressure rivet R and is articulated in 360° around its axis, which allows the user to choose the side or position that trash bin 1 will be inside the chosen location, as seen in FIG. 4.

The counterweight 8 of the lid 3 has a weight compatible with the total weight of the pivotable and foldable pedal 2 and allows the lowering of the lid 3 after the pivotable and foldable pedal 2 is activated by the user. The weight of the counterweight varies from 100 to 150 grams, depending on the size of the trash bin 1 used.

The size of the pivotable and foldable pedal 2 varies according to the size and weight of the trash bin 1.

The two front retractable feet 6 of the trash bin 1 serve to ensure greater stability of the trash bin 1 after activating the pivotable and foldable pedal 2, and because they are retractable, they enter the support structure 4 so that the trash bin 1 is eventually stored inside from a box to be marketed or when not in use.

The suction cups 7 serve to provide a better grip of the trash bin 1 on the ground so that it does not tip over to the sides or front.

The parts of the support structure 4 can be fastened together by screws, which can be replaced by butterfly screws, thus, allowing easier maintenance of the trash bin 1.

The measurements of trash bin 1 and structure 4 vary according to the size in liters of trash bin 1.

The material of trash bin 1 can be plastic, aluminum, stainless steel, plastic, fiberglass, biodegradable materials, among others. The material of the support structure 4 can be plastic, steel, metal, for example, iron, among others. The design, shape, color, weight, model of the trash bin 1 and the support structure 4 may also vary.

### Example—10 Liter Trash Bin

The dimensions of the 10 L trash bin are approximately 26 cm in diameter, 27 cm in height. In this case, the support has a height of approximately 43 cm.

For a 10 L trash bin, the counterweight fixed to the lid has a weight of approximately 105 g. The pivotable and foldable pedal 2 has a total length of approximately 60 cm.

The technical objective of the trash bin 1 with an pivotable and foldable pedal 2 of this utility model is to allow the user to open the trash bin 1 while sitting on the toilet, that is, without having to touch the lid of the trash bin 1 to open it, thus reducing the user's contact with possible viruses and bacteria that are in the lid 3 of the trash bin 1.

The user has the comfort of just stepping on the pivotable and foldable pedal 2 that can be positioned right next to the foot to open the lid 3 of the trash bin 1 without getting up from the toilet, thus, helping to obtain much better hygiene and in turn running less risk of contracting infectious diseases caused by viruses and bacteria, such as, for example, the coronavirus.

The pivotable and foldable pedal mechanism 2 allows the trash bin 1 to be used on both sides of the toilet, being very useful in homes with elderly people and people with motor dysfunctions. The trash bin 1 is also useful in shopping malls, hospitals, or other public places.

1. Trash bin (1) with pivotable and foldable pedal (2) comprising:
a lid (3); and
a support structure (4);
the support structure (4) comprising fixed feet (5) and front retractable feet (6), wherein the fixed feet (5) and the front retractable feet (6) comprise suction cups (7);
characterized in that the support structure (4) further comprises a pivotable and foldable pedal (2) comprising a first portion (2a) and a second portion (2b);
wherein the first portion (2a) of the articulated and foldable pedal (2) is attached to a rod (H) of the support structure (4) by means of a hinge (D), so that the pivotable and foldable pedal (2) is folded upwards at an angle of approximately 90° from its initial position (Pi) to its folded position (Pd);
wherein the second portion (2b) of the pivotable and foldable pedal (2) is attached to the first portion (2a) of the pivotable and foldable pedal (2) and is articulated and rotates 360° around its axis;
wherein the second portion (2b) of the pivotable and foldable pedal (2) is attached to the first portion (2a) of the pivotable and foldable pedal (2) by means of a pressure rivet (R); and
wherein the lid (3) comprises a counterweight (8) on its front part.

2. Trash bin, according to claim 1, characterized in that the parts of the support structure (4) are fastened together by screws.
